(19) United States
(12) Patent Application Publication
(10) Pub. No.: US 2025/0148474 A1
(43) Pub. Date: May 8, 2025

(54) PROCESSING PLATFORM

(71) Applicant: NationsBenefits, LLC, Plantation, FL (US)

(72) Inventors: Glenn Marc Parker, Ft. Lauderdale, FL (US); Michael Ethan Parker, Miami, FL (US); Larry Christopher Van Der Veen, San Carlos, CA (US); Grahame Andrew Jastrebski, San Jose, CA (US); Ming Ouyang, Sunnyvale, CA (US)

(73) Assignee: NationsBenefits, LLC, Plantation, FL (US)

(21) Appl. No.: 18/504,801

(22) Filed: Nov. 8, 2023

(51) Int. Cl. G06Q 20/40; G06Q 20/10; G06Q 20/12; G06Q 20/20

(52) U.S. Cl. CPC G06Q 20/405; G06Q 20/105; G06Q 20/12; G06Q 20/204

(57) ABSTRACT

Methods, systems, and storage media for processing transaction data are disclosed. Exemplary implementations may: receive transaction data wherein the transaction data is associated with the product purchased; analyze the transaction data; determine product eligibility for payment based on the program rules associated with the product purchased; and generate a transaction message indicating that the product or service was purchased.

### TECHNICAL FIELD

The present disclosure generally relates to processing platforms, and more particularly to processing transaction data.

### BACKGROUND

The use of electronic payment systems has become increasingly popular in recent years. These systems allow consumers to make purchases using electronic devices, such as smartphones or credit cards, instead of cash. However, there are still challenges associated with these systems, such as the need for secure and efficient transaction processing. Various methods have been developed to address these challenges, including the use of transaction identifications (IDs), unique messaging formats and proprietary payment processing paths.

### BRIEF SUMMARY

The subject disclosure provides for systems and methods for processing platforms. A user is allowed to reconcile and audit data by linking item data with pricing data using transaction IDs and purse summary information. One aspect of the present disclosure relates to a method for processing transaction data. The method may include receiving transaction data wherein the transaction data is associated with the product purchased. The purchase may include a transaction identifier. The method may include analyzing the transaction data. Analyzing the transaction data may include aggregating transaction data from a plurality of transactions, identifying program rules associated with the product purchased associated with each of the plurality of transactions. The method may include determining product eligibility for payment based on the program rules associated with the product purchased. The method may include generating a transaction message indicating that the product or service was purchased. The transaction message may include a transaction identifier. The method may include transmitting the transaction message to a merchant acquirer.

Another aspect of the present disclosure relates to a system configured for processing transaction data. The system may include one or more hardware processors configured by machine-readable instructions. The processor(s) may be configured to receive transaction data wherein the transaction data is associated with the product purchased. The transaction data may be generated based on a purchase with a purchase card. The purchase may be completed at a point of sale. The purchase may include a transaction identifier. The processor(s) may be configured to analyze the transaction data. Analyzing the transaction data may include aggregating transaction data from a plurality of transactions, identifying program rules associated with the product purchased associated with each of the plurality of transactions. The processor(s) may be configured to determine product eligibility for payment based on the program rules associated with the product purchased. The processor(s) may be configured to generate a transaction message indicating that the product or service was purchased. The transaction message may include a transaction identifier. The processor(s) may be configured to transmit the transaction message to a merchant acquirer.

Yet another aspect of the present disclosure relates to a non-transient computer-readable storage medium having instructions embodied thereon, the instructions being executable by one or more processors to perform a method for processing transaction data. The method may include receiving transaction data wherein the transaction data is associated with the product purchased. The transaction data may be generated based on a purchase with a purchase card. The purchase may be completed at a point of sale. The purchase may include a transaction identifier. The method may include auditing of the transaction data associated with the transaction identifier. Auditing the transaction data may include matching the product with pricing data associated with the product. The method may include analyzing the transaction data. Analyzing the transaction data may include aggregating transaction data from a plurality of transactions, identifying program rules associated with the product purchased associated with each of the plurality of transactions. The method may include determining product eligibility for payment based on the program rules associated with the product purchased. The method may include generating a transaction message indicating that the product or service was purchased. The transaction message may include a transaction identifier. The method may include transmitting the transaction message to a merchant acquirer.

Still another aspect of the present disclosure relates to a system configured for processing transaction data. The system may include means for receiving transaction data wherein the transaction data is associated with the product purchased. The purchase may include a transaction identifier. The system may include means for analyzing the transaction data. Analyzing the transaction data may include aggregating transaction data from a plurality of transactions, identifying program rules associated with the product purchased associated with each of the plurality of transactions. The system may include means for determining product eligibility for payment based on the program rules associated with the product purchased. The system may include means for generating a transaction message indicating that the product or service was purchased. The transaction message may include a transaction identifier.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates an example flow diagram for processing transaction data with proprietary elements, in accordance with one or more implementations.

FIG. 3 illustrates an example flow diagram for processing transaction data with independent elements, in accordance with one or more implementations.

FIG. 4 illustrates a system configured for processing platforms, in accordance with one or more implementations.

FIG. 5 illustrates an example flow diagram for processing platforms, according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In conventional payment processing, processing systems require that a private network be utilized to carry the customized formatted message between a Merchant Acquirer and an Issuer Processor. The merchant acquirer is a financial institution that processes a credit and/or debit card for a merchant, wherein the issuer processor can process a cart payload against business rules and i) a tender authorization and ii) the payment authorization to the proprietary payment network. Both the Merchant Acquirer and Issue Processor can be proprietary. Additionally, there may be a need for systems that can carry unique messages down any merchant acquirer and through specific fields.

This proprietary restriction is a technical problem because executing a payment from goods and/or services rendered results in several market inefficiencies, including the need for efficient linking of cart payload item data with pricing data for reconciliation and data audit purposes. For example, in the area of healthcare spend programs, providers of healthcare spend programs are able to restrict payment processing pathways by requiring a specific merchant acquirer for each program. The embodiment can also be used in other types of spend programs that may implement a set of rules to determine authorization for a potential purchase. In order to facilitate a payment processing, a retailer must support multiple interfaces to participate in other healthcare spend programs. Further, programs that utilize a closed network do not meet the Dodd-Frank Act requirements and therefore must utilize “closed-loop” payment media. To address the technical problem, the disclosure implements a SaaS Basket Analysis Service (BAS) module to utilize non-proprietary payment networks and components, including the merchant acquirer, the issuer processor, and the open loop network.

The BAS Module eliminates the reliance on proprietary payment networks and related issuer processors by providing directed spend adjudication rules and financial system of record functions separate from payment network. Current implementation requires that adjudication and financial system of record roles be performed by the proprietary closed-loop issuer processor, necessitating that a proprietary transaction payload be transacted across a proprietary closed-loop network. The BAS module operates as a cloud-based SaaS, combining the functions of directed spend adjudication protocols and financial system of record roles that are disassociated from the payment network. The effect of this disassociation allows retailers to integrate with any open-loop payment network composed of any merchant acquirer, financial rail, or issuer processor.

The BAS Module can build transaction IDs and link item data with pricing data during the purchase of goods and services at a POS terminal. Using the actions of the BAS Module, items purchased from an integrated POS terminal can be accomplished by using any generic (non-proprietary) merchant acquirer or issuer processor. A benefit of the implement the BAS Module is that the payment process does not need formatting and nor creating any unique proprietary message that can be transmitted through the payment processing network. Some implementations may also include a system of record for this data, which allows for efficient reconciliation and data audit. As a result, retailers are allowed to utilize their existing networks and partnerships. The result of the disclosure can also be extended beyond directed-spend programs for healthcare to other payment programs wherein payment processing requires an adjudication based on spend program rules at the point-of-sale (POS).

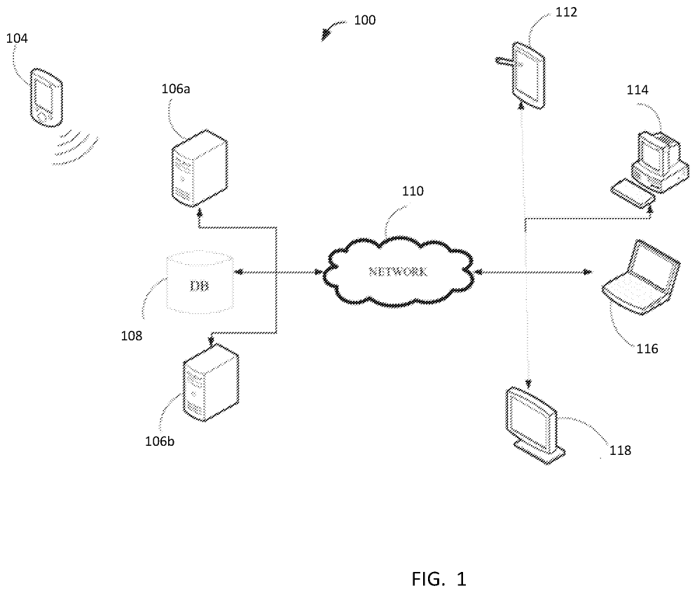

FIG. 1 is a block diagram illustrating an overview of an environment 100 in which some implementations of the disclosed technology can operate. The environment 100 can include one or more client devices, such as mobile devices 104, tablets 112, personal computers 114, laptops 116, desktops 118, and/or the like. Client devices may communicate wirelessly via the network 110. The client devices can operate in a networked environment using logical connections through network 110 to one or more remote computers, such as server computing devices. The server computing devices 106-a-106b may be configured to provide a basket adjudication services and other related services to one or more of the client devices. The client devices and computing devices can function as a POS. At the POS, a user can engage with the POS using a credit/debit card, digital wallet or other form of digital payment.

In some implementations, the environment 100 may include an edge server which receives client requests and coordinates fulfillment of those requests through other servers. The server may include the server computing devices 106-a-106b, which may logically form a single server. Alternatively, the server computing devices 106-a-106b may each be a distributed computing environment encompassing multiple computing devices located at the same or at geographically disparate physical locations. Alternatively, the server computing may be in public cloud. The client devices and server computing devices 106-a-106b can each act as a server or client to other server/client device(s). The server computing devices 106-a-106b can connect to a database 108 or can comprise its own memory. Each server computing device 106-a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations or in public cloud. The database 108 can store data indicative of adjudication and payment transactions were attempted by a given Client/POS user using the BAS.

The network 110 can be a local area network (LAN), a wide area network (WAN), a mesh network, a hybrid network, or other wired or wireless networks. The network 110 may be the Internet or some other public or private network. Client devices can be connected to network 110 through a network interface, such as by wired or wireless communication. The connections can be any kind of local, wide area, wired, or wireless network, including the network 110 or a separate public or private network. In some implementations, the server computing devices 106-a-106b can be used as part of a payment enabling system such as implemented via the network 110. The payment platform can facilitate payments by users through secure and encrypted transactions. Some transaction messaging can be formatting using an ISO standard or an arrangement of discrete elements.

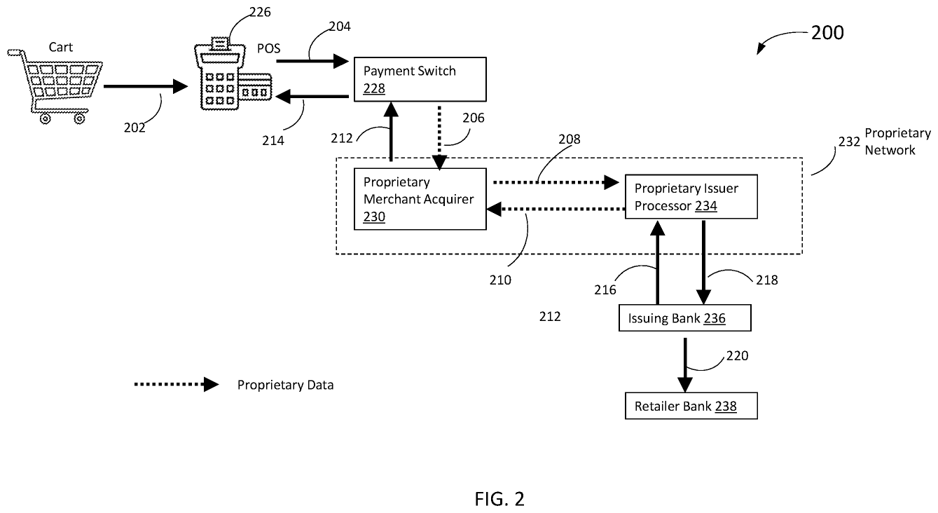

In conventional payment processing, as displayed in FIG. 2, processing systems require that a private network be utilized to carry the customized formatted message between a Merchant Acquirer and an Issuer Processor. Some implementations involve a system for processing transactions that involves building transaction IDs with cart payload from the summary information. This information is later used to link item data with pricing data for reconciliation and data audit. The system may involve a cart payload that product data arrives in, along with the price for reconciliation and data audit. This information may be used to build transaction IDs and link item data with pricing data. During an example transaction, a customer may seek to purchase multiple items associated with healthcare along with various personal items. The system is charged with processing the potential transaction by determining if the customer may be authorized to purchase the items under the healthcare and further if the customer has the necessary funds to cover the purchase of those items.

FIG. 2 illustrates an example flow diagram 200 for conventional payment processing flow using proprietary message through the specific merchant acquirer and issuer processor. To carry the customized formatted message, the processing method may utilize a customized message to carry a multi-purse authorization request that can be carried down to a particular merchant acquirer. Processing a payment in the conventional manner requires a proprietary merchant acquirer 230 and proprietary issuer processor 234 to execute a transaction at a POS 226. Sending messages via the payment rails to entities of the payment network using the conventional network structure requires a proprietary/closed loop network. The network can be characterized as proprietary because the file format of the data messages are required to be in a particular format that is consistent of the requirements of the respective network components. At step 202, a transaction is initiated at a POS 226 for scanning and tender. The product or service purchased may be an item or service purchased at the point-of-sale using a purchase card. As the product is identified, the transaction message may involve constructing the transaction IDs with the purse summary information and using this information to later link item data with pricing data for reconciliation and data audit. At step 204, the transaction comprises cart content, wherein the content is formatted and presented to merchant's payment switch 228.

At step 206, the payment switch 228 can forward the cart load and tender transaction to a proprietary merchant acquirer 230. At step 208, through a proprietary network 232, the merchant acquirer 230 can prepare and forward in a proprietary format consistent the requirements of the proprietary network, a transaction carrying the cart payload, wherein the transaction is submitted to the proprietary issuer processor 234. At step 210, issuer processor 234 processes the cart payload against the business rules and returns a tender authorization to the merchant acquirer 230 via the proprietary network 232. At step 212, the tender authorization is routed to the payment switch. At step 214, the payment switch 228 notifies the POS of the tender authorization. At step 216, the issuer processor notifies the issuing bank 236 to move money to the retailer. At step 218, payment can be confirmed to the issuing bank 236. At step 220, payment is transferred to the retailer merchant bank 238.

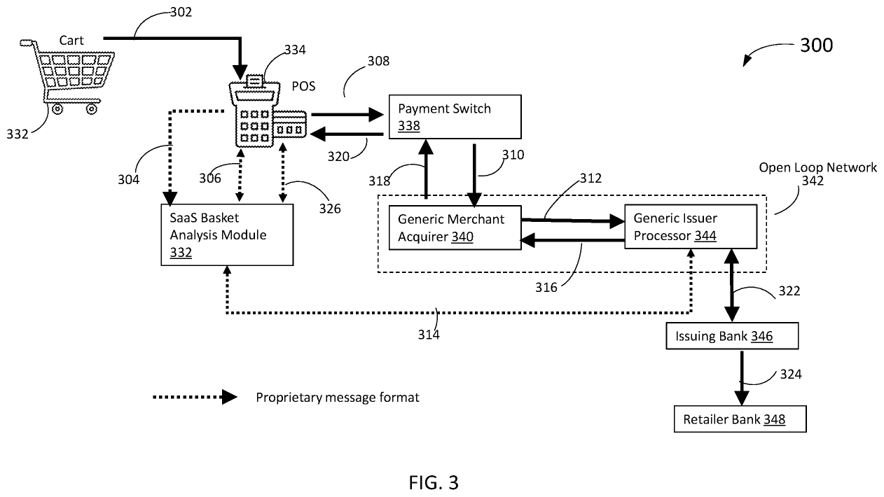

In contrast to the conventional payment process in FIG. 2, FIG. 3 illustrates an example flow diagram 300 associated with the current status for processing payments that allows a generic merchant acquirer 340 and issuer processor 344. FIG. 3 illustrates an example flow diagram (e.g., process 300) for processing transaction data with a generic issuer processor, in accordance with one or more implementations. For explanatory purposes, the steps of the example process 300 are described herein as occurring in serial, or linearly. However, multiple instances of the example process 300 may occur in parallel. At step 302, cart contents are presented for scanning and tender; this action may occur through a client (e.g., through a browser, a mobile device, and/or a point-of-sale (POS) device 334). The shopping cart may contain goods and services selected for acquisition by a client. At step 304, the shopping cart 332 contents can be formatted and presented to the BAS Module.

At step 306, BAS Module 332 can adjudicate cart content and pre-processes payment information through a ledger. The pre-process may include determining product eligibility within a specific program using the basket analysis service to compare basket products using specific program rules. The program rules can include a particular health program or other set of program rules. The BAS Module 332 may define an application program interface API structure that allows the POS to present the entire shopping cart data for adjudication following a tender action at the POS. The (API) structure can be facilitate communication between the POS and BAS. The API describes the shopping event in two major data sections: 1) transaction information and 2) cart content information. Transaction information consists primarily of those data elements that define the specific merchant and POS device initiating the transaction, such as merchant identifier (MID), terminal identifier (TID), as well as timestamps and transaction IDs to identify the specific transaction, and an identification of the Member. The cart content section includes a record for each specific line item being purchased within the transaction. Detailed information typically includes an item description consisting of a product code, unit price, unit of measure, tax and fee elements, weight, and product description.

In a further aspect, the BAS Module can comprise a product eligibility engine. The product eligibility engine can adjudicate transaction data by managing and applying rules for financial constraints, line-item level eligibility and velocity constraint. The product eligibility engine can further include a plan and retailer constraint to determine accessibility for a particular retailer and/or a plan constraint such as health care plan. The BAS Module 332 can analyze and record qualified purchase activities. The BAS Module can also store data to generate a system of record for compliance, audit and analytic study. The BAS Module 332 can further engage in collaborative authorization to manage tender authorizations and transactional integrity. The BAS Module 332 can execute account ledgers for maintaining balances for each type of account (e.g. Member, Funding (FBO), Digital discounts, rewards and spending certificates), for accounts generated under the rules of the spend program.

The collaborative authorization can comprise processing the authorization request and returning a tender authorization. Some implementations authorization may include receiving transaction data, which includes a transaction identifier and information about the product purchased. The transaction data may be analyzed by aggregating data from multiple transactions and identifying program rules associated with the purchased product. The program rules may be used to determine product eligibility for payment. Once the product eligibility is determined, a transaction message may be generated that indicates the product or service was purchased. An authorization response may be provided by the independent issuer processer 344 to the merchant acquirer. The message may include a transaction identifier and be transmitted to a merchant acquirer 342. The transaction data may be audited by matching the product with pricing data associated with the product.

At step 308, a POS 334 may tender authorization request to payment switch 338 based upon BAS Module analysis. At step 310, the payment switch 338 can forward tender transaction to a generic merchant acquirer 340 in an open-loop network 342. Unlike the restrictions in a proprietary merchant acquirer 230 in a proprietary network 232, generic merchant acquirer 340 does not require a particular file format to execute a function of the payment process. At step 312, the Merchant Acquirer 340 can prepare and forward a standard ISO8583 authorization request, and the standard authorization request can be routed through the open-loop network 342. At step 314, the issuer processor 344 can perform a collaborative authorization with the BAS Module 332. Further, the generic issuer processor 344 can process the authorization request and returns a tender authorization. The proprietary format in the collaboration process between the generic issuer processor 344 and the BAS 332 is different from the proprietary data structures in FIG. 2. because the format is mutually agreed upon and not determined by the requirements of a proprietary network 232 and proprietary issuer processor 234.

The preprocessing between the BAS 332 and generic issuer processor 334 examines the entire content of the cart and marks each item as eligible or ineligible, as well as determines how much will be paid for each eligible item. During any payment request from the POS, the BAS (including payment authorization or payment decline) can authorize: 1) full payment for all items in the cart; 2) decline payment for all items in the cart; or 3) authorize a split tender wherein some of the items authorized for payment and others are declined due to balance limits or having non-eligible items in the basket, wherein the POS is required to handle “split tender” transactions under the requirements of the program spend program rules.

At step 316, the tender authorization generated by the generic issuer processor 344 is routed to the generic merchant acquirer 340 via the open loop network 342. At step 318, the tender authorization is routed to payment switch 338 from the merchant acquirer. At step 320, the payment switch 338 can notify the POS 334 of the tender authorization. At step 322, the generic Issuer Processor 342 notifies issuing bank 346 of a requirement to move money to Retailer. At step 326, the payment is transferred to a retailer bank. At step 328, The POS 334 can inform the BAS Module 332 that the transaction was approved.

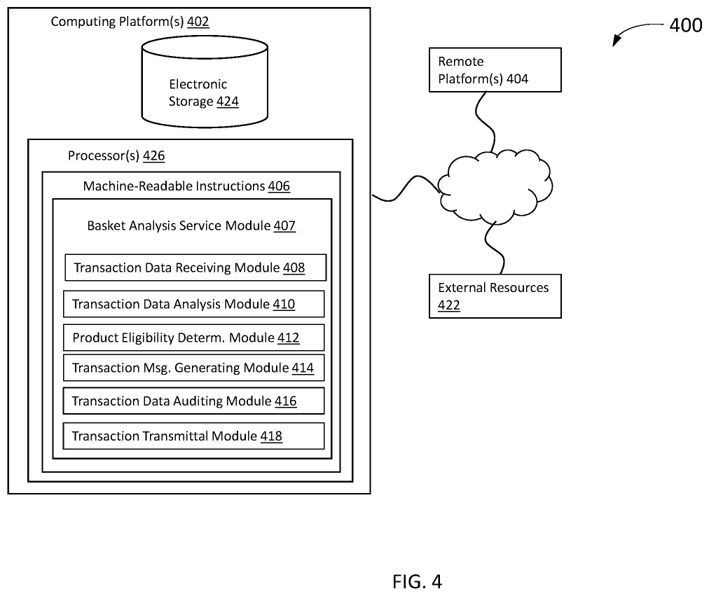

FIG. 4 illustrates a system 400 configured for processing platforms, according to certain aspects of the disclosure. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction module can comprise a BAS Module 407 that may include computer program modules. The BAS Module 407 may include one or more of transaction data receiving module 408, transaction data analysis module 410, product eligibility determination module 412, transaction message generating module 414, transaction data auditing module 416, transaction transmittal module 418, and/or other instruction modules.

Transaction data receiving module 408 may be configured to receive transaction data wherein the transaction data is associated with the product purchased. The transaction data may be generated based on a purchase with a purchase card. The product may be an item purchased at a point-of-sale or a service purchased at the point-of-sale. The transaction data may include information about a purse type associated with the product purchased. The purse type may be associated with a healthcare benefit. The transaction data may include a location where the purchase was made. The transaction data may include a date and time of purchase. The transaction data may include a product code associated with the product purchased. The product code may be associated with a specific medical condition. The transaction data may include an amount of funds available in a payment purse associated with the product purchased. The transaction data may include a type of purchase made, such as a co-pay or deductible. The transaction data may include a type of merchant where the purchase was made, such as a doctor's office or hospital. The transaction data may include a cardholder's name and address. The transaction data may be stored in a secure database. The transaction data may include a reason for the purchase, such as a medical condition or prescription. The purchase may include a transaction identifier.

Transaction data analysis module 410 may be configured to analyze the transaction data. Analyzing the transaction data may include aggregating transaction data from a plurality of transactions. Analyzing the transaction data may include identifying program rules or business rules associated with the product or service purchased. In some implementations, the purchase may be completed at a point of sale. In some implementations, a payment device used to complete the transaction may be identified. In some implementations, the payment device may be a mobile device. In some implementations, the merchant associated with the transaction may be identified.

Product eligibility determination module 412 may be configured to determine product eligibility for payment based on the program rules associated with the product purchased. The eligibility of the product for payment may be verified. Analyzing the transaction data may include determining the product eligibility. Determining product eligibility for payment based on the program rules associated with the product purchased may further include verifying a cardholder's eligibility for a benefit. The program rules associated with the product purchased may be updated in real time based on changes in a purse sponsor's benefit plan. The program rules associated with the product purchased may be adjusted based on a cardholder's spending habits. In a further aspect, the product eligibility module can also determine a purse associated with each of the program rules. The purse can comprise a monetary allotment for a category of goods under the program rules. For example, in a health care spend program there can be a purse for prescriptions, a purse for co-pays, and a purse for home medical devices (e.g. crutches, inhalers, and the like). Each of the purses can be managed by the BAS by a ledger generated for each purse. As transactions are authorized or denied, the BAS can update the monetary allotment and/or other incentives that can be associated with that respective purse in accordance with the program rules.

Transaction message generating module 414 may be configured to generate a transaction message indicating that the product or service was purchased. A cardholder may be notified of the transaction message. The transaction message may include a response code indicating whether the payment was approved or declined. The transaction message may include a merchant identifier. The transaction message may include an amount of funds available in the payment purse associated with the product purchased. The transaction message may include a transaction identifier.

Transaction data auditing module 416 may be configured to audit the transaction data associated with the transaction identifier. Auditing the transaction data may include matching the product with pricing data associated with the product. In some implementations, a log entry for the transaction may be created.

Transaction transmittal module 418 may be configured to transmit all transaction to a third party. In some implementations, a detailed breakdown of the purchase may be provided to a cardholder. Rewards may be provided to a cardholder based on the transaction data. A receipt for a cardholder may be generated after the payment is approved.

In some implementations, computing platform(s) 402, remote platform(s) 404, and/or external resources 422 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 422 may be operatively linked via some other communication media.

A given remote platform 404 may include one or more processors configured to execute computer program modules. The computer program modules may be configured to enable an expert or user associated with the given remote platform 404 to interface with system 400 and/or external resources 422, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a Smartphone, and/or other computing platforms.

External resources 422 may include sources of information outside of system 400, external entities participating with system 400, and/or other resources. In some implementations, some or all of the functionality attributed herein to external resources 422 may be provided by resources included in system 400.

Computing platform(s) 402 may include electronic storage 424, one or more processors 426, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 424 may comprise non-transitory storage media that electronically stores information. The electronic storage media of electronic storage 424 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 424 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 424 may include one or more virtual storage resources (e.g., cloud storage, a virtual private network, and/or other virtual storage resources). Electronic storage 424 may store software algorithms, information determined by processor(s) 426, information received from computing platform(s) 402, information received from remote platform(s) 404, and/or other information that enables computing platform(s) 402 to function as described herein.

Processor(s) 426 may be configured to provide information processing capabilities in computing platform(s) 402. As such, processor(s) 426 may include one or more of a digital processor, an analog processor, a digital circuit designed to process information, an analog circuit designed to process information, a state machine, and/or other mechanisms for electronically processing information. Although processor(s) 426 is shown in FIG. 4 as a single entity, this is for illustrative purposes only. In some implementations, processor(s) 426 may include a plurality of processing units. These processing units may be physically located within the same device, or processor(s) 426 may represent processing functionality of a plurality of devices operating in coordination. Processor(s) 426 may be configured to execute modules 408, 410, 412, 414, 416, and/or 418, and/or other modules. Processor(s) 426 may be configured to execute modules 408, 410, 412, 414, 416, and/or 418, and/or other modules by software; hardware; firmware; some combination of software, hardware, and/or firmware; and/or other mechanisms for configuring processing capabilities on processor(s) 426. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 426 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of its functionality may be provided by other ones of modules 408, 410, 412, 414, 416, and/or 418. As another example, processor(s) 426 may be configured to execute one or more additional modules that may perform some or all of the functionality attributed below to one of modules 408, 410, 412, 414, 416, and/or 418.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

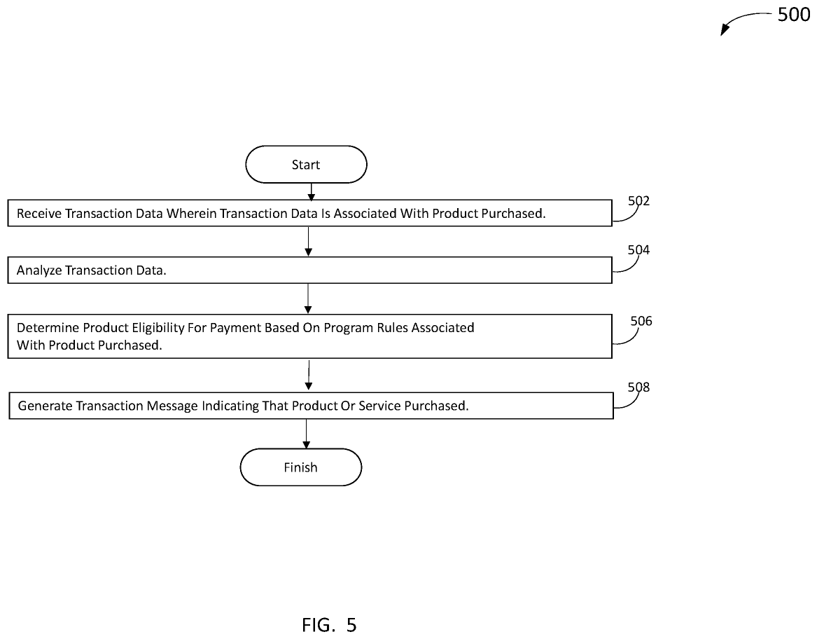

FIG. 5 illustrates an example flow diagram (e.g., process 500) for processing platforms, according to certain aspects of the disclosure. For explanatory purposes, the example process 500 is described herein with reference to FIGS. 1-4. Further for explanatory purposes, the steps of the example process five hundred are described herein as occurring in serial, or linearly. However, multiple instances of the example process 500 may occur in parallel.

At step 502, the process 500 may include receiving transaction data wherein the transaction data is associated with the product purchased. The purchase may include a transaction identifier. At step 504, the process 500 may include analyzing the transaction data. Analyzing the transaction data may include aggregating transaction data from a plurality of transactions, identifying program rules associated with the product purchased associated with each of the plurality of transactions. At step 506, the process 500 may include determining product eligibility for payment based on the program rules associated with the product purchased. At step 508, the process 500 may include generating a transaction message indicating that the product or service was purchased. The message may include a transaction identifier.

For example, as described above in relation to FIG. 4, at step 502, the process 500 may include receiving transaction data wherein the transaction data is associated with the product purchased, through transaction data receiving module 408. The purchase may include a transaction identifier. At step 504, the process 500 may include analyzing the transaction data, through transaction data analysis module 410. Analyzing the transaction data may include aggregating transaction data from a plurality of transactions, identifying program rules associated with the product purchased associated with each of the plurality of transactions. At step 506, the process 500 may include determining product eligibility for payment based on the program rules associated with the product purchased, through product eligibility determination module 412. At step 508, the process 500 may include generating a transaction message indicating that the product or service was purchased, through transaction message generating module 414. The message may include a transaction identifier.

According to an aspect, the transaction data is generated based on a purchase with a purchase card, wherein the purchase is completed at a point of sale.

According to an aspect, the process 500 may include auditing of the transaction data associated with the transaction identifier.

According to an aspect, auditing the transaction data comprises matching the product with pricing data associated with the product.

According to an aspect, the process 500 may include applying digital discounts to transaction data.

According to an aspect, the process 500 may include transmitting all transactions to a third party.

According to an aspect, the product is an item purchased at a point-of-sale or a service purchased at the point-of-sale.

According to an aspect, the transaction data further comprises information about a purse type associated with the product purchased.

According to an aspect, the purse type is associated with a healthcare benefit.

According to an aspect, the transaction data further comprises a location where the purchase was made.

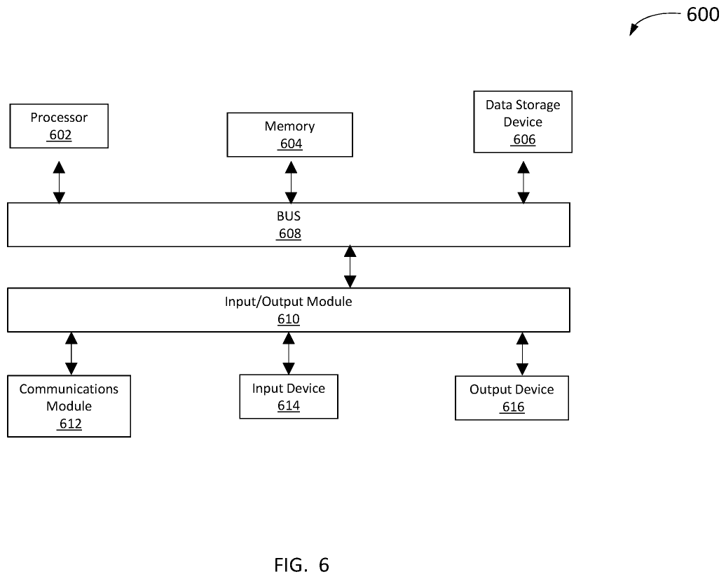

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, printers, for displaying information to the user.

According to one aspect of the present disclosure, the above-described systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, Wi-Fi, Bluetooth, NFC, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads data, the data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include.” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for processing transaction data, the method comprising:
receiving transaction data wherein the transaction data is associated with a product purchased, wherein the purchase comprises a transaction identifier;
analyzing the transaction data, wherein analyzing the transaction data includes:
aggregating transaction data from a plurality of transactions,
identifying program rules associated with the product purchased associated with each of the plurality of transactions, and
determining product eligibility for payment based on the program rules associated with the product purchased; and
generating a transaction message indicating that the product or service was purchased, wherein the transaction message comprises a transaction identifier.

2. The method of claim 1, wherein the transaction data is generated based on a purchase with a purchase card, wherein the purchase is completed at a point of sale.

3. The method of claim 1, further comprising auditing of the transaction data associated with the transaction identifier.

4. The method of claim 3, wherein auditing the transaction data comprises matching the product with pricing data associated with the product.

5. The method of claim 1, further comprising generating at least one purse, where in the purse comprises an account associated with the program rules associated with the product purchased.

6. The method of claim 5, further comprising determining a ledger associated with the at least wherein the ledger is adjusted in response to a determination of product eligibility.

7. The method of claim 1, wherein the product is an item purchased at a point-of-sale or a service purchased at the point-of-sale.

8. The method of claim 1, wherein the transaction data further comprises information about a purse type associated with the product purchased.

9. The method of claim 8, wherein the purse type is associated with sponsored benefits program.

10. The method of claim 1, wherein the transaction data further comprises a location where the purchase was made.

11. A system configured for processing transaction data, the system comprising:
one or more hardware processors configured by machine-readable instructions to:
receive transaction data, wherein the transaction data is associated with a product purchased, wherein the transaction data is generated based on a purchase with a purchase card, wherein the purchase is completed at a point of sale, wherein the purchase comprises a transaction identifier;
analyze the transaction data, wherein analyzing the transaction data includes:
aggregating transaction data from a plurality of transactions,
identifying program rules associated with the product purchased associated with each of the plurality of transactions, and
determining product eligibility for payment based on the program rules associated with the product purchased; and
generate a transaction message indicating that the product or service was purchased, wherein the transaction message comprises a transaction identifier.

12. The system of claim 11, wherein a payment device used to complete the transaction is identified.

13. The system of claim 12, wherein the payment device is a mobile device.

14. The system of claim 11, wherein rewards are provided to a cardholder based on the transaction data.

15. The system of claim 11, wherein a merchant associated with the transaction is identified.

16. The system of claim 11, wherein the eligibility of the product for payment is verified.

17. The system of claim 11, wherein determining product eligibility for payment based on the program rules associated with the product purchased further comprises verifying a cardholder's eligibility for a benefit.

18. The system of claim 11, wherein the transaction data further comprises a product code associated with the product purchased.

19. The system of claim 11, wherein the program rules associated with the product purchased are updated in real time based on changes in a purse sponsor's benefit plan.

20. A non-transient computer-readable storage medium having instructions embodied thereon, the instructions being executable by one or more processors to perform a method for processing transaction data, the method comprising:
receiving transaction data wherein the transaction data is associated with a product purchased, wherein the transaction data is generated based on a purchase with a purchase card, wherein the purchase is completed at a point of sale, wherein the purchase comprises a transaction identifier;
auditing of the transaction data associated with the transaction identifier, wherein auditing the transaction data comprises matching the product with pricing data associated with the product;
analyzing the transaction data, wherein analyzing the transaction data includes:
aggregating transaction data from a plurality of transactions,
identifying program rules associated with the product purchased associated with each of the plurality of transactions, and
determining product eligibility for payment based on the program rules associated with the product purchased; and
generating a transaction message indicating that the product or service was purchased. wherein the transaction message comprises a transaction identifier.
